(19) United States
(12) Patent Application Publication
(10) Pub. No.: US 2022/0111622 A1
(43) Pub. Date: Apr. 14, 2022

(54) MULTILAYER PACKAGING FILM

(71) Applicant: Bemis Company, Inc., Neenah, WI (US)

(72) Inventors: Carol W. Umphlett, Appleton, WI (US); Melissa Kanzelberger Coolich, Hortonville, WI (US); Alyssa Obert, Commerce Township, MI (US)

(21) Appl. No.: 17/264,814

(22) PCT Filed: Jul. 31, 2018
(86) PCT No.: PCT/US2018/044569

§ 371 Date: Jan. 30, 2021

(51) Int. Cl. B32B 27/08; B32B 27/32; B32B 7/12; B32B 27/34; B32B 27/36; B32B 1/00; B65D 65/40; B65D 75/00

(52) U.S. Cl. CPC B32B 27/08; B32B 2439/80; B32B 7/12; B32B 27/34; B32B 27/36; B32B 1/00; B65D 65/40; B65D 75/008; B32B 2270/00; B32B 2307/518; B32B 2255/20; B32B 2255/10; B32B 2307/54; B32B 2250/24; B32B 2439/46; B32B 2307/31; B32B 2439/70; B32B 27/32

(57) ABSTRACT

A multilayer film that has improved ultrasonic sealing properties is disclosed. The multilayer film includes a first layer and a second layer. The second layer includes a first sublayer composed of a polypropylene copolymer, a thermoplastic polyolefin having a modulus of 1,700 MPa or less, and olefin block copolymer. The second layer further includes a second sublayer composed of a polypropylene homopolymer or polypropylene copolymer. A laminating agent may be positioned between the first layer and the second layer. The multilayer film has a seal initiation temperature of greater than 105 degrees Celsius, in some embodiments, packages made from the multilayer film are adapted to withstand exposure to high heat pasteurization of greater than 70 degrees Celsius.

### TECHNICAL FIELD

This disclosure is related to flexible, multilayer packaging film for food and non-food items, and in particular, to films that include a sealant layer composition that improves ultrasonic sealing properties of the packaging film. The film also demonstrates acceptable heat sealing properties.

### BACKGROUND

Many items can be packaged via form-fill-seal equipment as is known in the art. For example, in the vertical form-fill-seal (VFFS) or in the horizontal form-fill-seal (HFFS) arrangements, flexible packaging film is fed from a roll-stock to a tube former, a tube is fashioned from the film, and the tube includes overlapping longitudinal edges. The overlapping edges are subsequently sealed together forming a longitudinal seal and the ends of the tube are sealed together by a pair of transverse seals which are vertically spaced apart. Items can also be packaged in bags that are not formed with the form-fill-seal processes. The bags, or pouches, are formed from flexible packaging film prior to placing the package contents inside of the pouch. Some edges of the flexible packaging film are sealed together to form the pouch, contents are then placed inside of the pouch and the remaining unsealed edges are sealed to close the package. Pouches may include a gusset member that allows the pouch to stand up.

Oxygen or moisture sensitive items can be packaged with flexible packaging film that may include a barrier layer(s) of material that prevents the ingress of oxygen and/or moisture. Further, oxygen sensitive items can be sterilized by a hot-fill or aseptic operation during the packaging process or by a retort operation after the product is packaged. Sterilization by these operations imposes several, severe restrictions on the choice of materials for the packaging film and the seals forming the package. For example, seals must survive sterilization temperatures of over 70 degrees Celsius or typical retort conditions of steam or water at 121 degrees Celsius or higher under pressure for one half hour or more. Retort conditions described herein may be similar to those described in WO18118068A1, filed Dec. 22, 2016, incorporated herein by reference. The oxygen and moisture barrier properties of the packaging material must not be adversely affected by the conditions of sterilization. Additionally, the seals of the package need to have sufficient seal strength to resist 1) the physical and mechanical abuse imposed by the sealing or food packaging processes and 2) the shearing and/or compression forces resulting from the relatively high temperatures and pressures during the sterilization process.

A thermal-based process may be used to form the seals, that is, to affix the packaging material to itself. A thermal-based sealing process typically brings the surfaces of the packaging film together under heat and pressure. The terms “heat-seal” and “heat sealing” are used interchangeably hereinafter and are well-known in the art as thermal-based seals.

An alternative sealing method involves “ultrasonic welding” or “ultrasonic sealing”; these terms are used interchangeably hereinafter. Generally, this method works by generating a high voltage that is converted into high frequency vibrations. The high frequency vibrations lead to interfilm and intermolecular friction within a defined seal area of the packaging film. Heat generated by this friction seals the surfaces of the packaging film together.

Ultrasonic sealing has become an attractive means for sealing packages. This method permits sealing through contaminants that may be in the seal area and that may include the package contents (such as food) and allows for high seal strengths. In contrast, thermal-based sealing processes do not seal well through contaminates in the seal area. Ultrasonic sealing also relates to raw material cost savings. The packaging film surfaces may overlap by as much as 10 mm in a heat sealing process. A portion of this overlap is not part of the seal or weld and is thus wasted film. Ultrasonic sealing requires a smaller overlap that can be as small as 6 mm, which when multiplied by thousands of packages per hour in the context of a manufacturing setting, is a significant reduction in waste. Further, ultrasonic seals allow for a narrower weld than a heat-seal having comparable strength.

Current laminated film structures that are used with ultrasonic sealing typically include a minimum of four layers to avoid damage of the film structure in the seal area. A reduction from four layers in a laminated film structure for ultrasonic sealing would provide a cost advantage over current films for ultrasonic sealing.

### SUMMARY

There is a need for a laminated, multilayer film that 1) can be ultrasonically sealed, 2) can be heat sealed, 3) can withstand sterilization processes, notably a retort process, and 4) includes three or fewer layers.

The present application describes a multilayer film that may be suitable for ultrasonic sealing. In one embodiment, the multilayer film includes a first layer and a second layer that includes a first sublayer and a second sublayer. The first sublayer includes a polypropylene copolymer, a thermoplastic polyolefin having a modulus of less than 1,700 MPa, and an olefin block copolymer. The second sublayer includes a polypropylene homopolymer or polypropylene copolymer. A laminating agent may be positioned between the first layer and the second layer. The multilayer film has a seal initiation temperature of greater than 105 degrees Celsius.

Further, the second layer may be a coextrusion of the first sublayer and the second sublayer. The second layer may further include a blown film or a cast film. The first layer may include a first oriented film that may include oriented polyester, oriented polyamide, oriented polypropylene, or oriented polyethylene. The first layer may include a first barrier film that may include polyamide, ethylene vinyl alcohol copolymer, polyvinyl chloride, glass, thermoplastic polyurethane, polyester, or blends or coextrusions thereof, or aluminum foil, aluminum oxide coated polyester, or other barrier coatings. The laminating agent may include an adhesive that includes a polyurethane-based adhesive. The multilayer film may further include a third layer that includes a second oriented film and the third layer is positioned exterior to the first layer. The multilayer film may further include a third layer that includes a second barrier film and the third layer is positioned exterior to the first layer. The second sublayer may include a polypropylene homopolymer in an amount of from 0 to 50 percent by weight of the second sublayer. The first sublayer may include a thermoplastic polyolefin having a modulus of less than 1,700 MPa in an amount of from 10 to 60 percent by weight of the first sublayer.

In another embodiment, a multilayer film includes a first layer including an oriented film that includes polyamide, and a second layer including a first sublayer and a second sublayer. The first sublayer includes a propylene-based random copolymer in the amount of from 10 to 80 percent by weight of the first sublayer, a thermoplastic polyolefin having a modulus of less than 1,700 MPa in an amount of from 10 to 40 percent by weight relative of the first sublayer, and an olefin block copolymer in an amount of from 10 to 50 percent by weight of the first sublayer. The second sublayer includes a polypropylene homopolymer or a polypropylene copolymer. A laminating agent may be positioned between the first layer and the second layer. A third layer includes a barrier film including ethylene vinyl alcohol copolymer and is positioned exterior to the first layer. The second layer includes a coextrusion of the first sublayer and the second sublayer. The multilayer film has a seal initiation temperature of greater than 105 degrees Celsius.

Further, the multilayer film may be adapted to withstand exposure to high heat pasteurization of greater than 70 degrees Celsius. A hermetically sealed package may include the multilayer film.

In any embodiment, the multilayer film may have a peak seal strength of from 1.40 N/mm to 20.00 N/mm when sealed at a seal temperature from 127 degrees Celsius to 221 degrees Celsius.

In any embodiment, the multilayer film may have a peak seal strength greater than 4.00 N/mm when sealed ultrasonically at an energy of at least 50 Joules.

In any embodiment, the multilayer film may have a seal initiation temperature of from greater than 105 degrees Celsius to 180 degrees Celsius.

In any embodiment, the thermoplastic polyolefin may have a modulus of from 10 MPa to less than 1,700 MPa.

In any embodiment, the first sublayer is essentially free of polypropylene homopolymer.

### BRIEF DESCRIPTION OF THE DRAWINGS

Other objects and advantages of the present disclosure will become more apparent to those skilled in the art in view of the following description and the accompanying figures.

FIG. 1 illustrates a cross-sectional view of a first embodiment of a multilayer film.

FIG. 2 illustrates a cross-sectional view of a second embodiment of a multilayer film.

FIG. 3 illustrates a cross-sectional view of a third embodiment of a multilayer film.

FIG. 4 illustrates a cross-sectional view of a fourth embodiment of a multilayer film.

FIG. 5 illustrates a perspective view of a product packaged in a stand-up pouch wherein the package is made from a multilayer film.

FIG. 6 illustrates a chart of heat seal strength values at incremental temperatures for various multilayer films.

FIGS. 7A-7G illustrate several charts of ultrasonic seal strength values at incremental energy values for various multilayer films.

The figures show some but not all embodiments. The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

A multilayer, laminated film for ultrasonic sealing is described herein. The film at least has a first layer and a second layer, wherein the first layer can function as an abuse or barrier layer and the second layer can function as a sealant layer, as are known in the art. The second layer, or sealant layer, has at least a first sublayer and a second sublayer. The first sublayer includes a polypropylene copolymer, a thermoplastic polyolefin having a flexural modulus of from 10 MPa to less than 1,700 MPa, and an olefin block copolymer. The second sublayer includes a polypropylene homopolymer or a polypropylene copolymer. The first layer and the second layer may be laminated to each other with a laminating agent. The film has a seal initiation temperature of greater than 105 degrees Celsius. The term “seal initiation temperature” as used herein, is the first temperature above ambient at which a seal can form by applying a given temperature and pressure to a given thickness of packaging film for a given length of time. Further, a hermetically sealed package can be made from the film.

The term “layer” as used herein, refers to a structure of a single polymer-type or a blend of polymers that may be accompanied by additives and that may be continuous or discontinuous.

The term “sublayer” as used herein, refers to a structure of a single polymer-type or blend of polymers that may be accompanied by additives and that may be continuous or discontinuous and that is a subunit of a layer. For example, a layer composed of sublayers may include at least two sublayers.

With reference to FIG. 1, a multilayered film 10 is shown. The film 10 includes a first layer 20, a second layer 30, and a laminating agent 40 positioned between the first layer 20 and the second layer 30.

First Layer

The first layer 20 can function as a barrier layer. Barrier polymers or barrier materials are generally known to reduce the transmission of a gas or water vapor through the film. Barrier materials may be required for some embodiments where the multilayer film 10 will be used to package product, such as food, in order to preserve quality of the packaged product through distribution and to extend shelf life. For example, in some instances, a moisture barrier is required to prevent a product from drying out (losing moisture content). In other instances, an oxygen barrier is required to prevent ingress oxygen from degrading a product prematurely. In some embodiments, the first layer 20 may be composed of, but not limited to, polyamide, polyamide blends, ethylene vinyl alcohol copolymer (EVOH), polyvinyl chloride, polyvinylidene chloride, glass, thermoplastic polyurethane (TPU), polyethylene terephthalate copolymer, and may be blends or coextrusions thereof. The first layer 20 may also be composed of metal layers, such as aluminum foil, metal coated plastic films, ceramic coated films, or aluminum oxide coated films, or other barrier coatings as is known in the art.

The terms “polyamide” or “PA” or “nylon” as used herein, refers to a homopolymer or copolymer having an amide linkage between monomer units and formed by any method known in the art. Polyamides useful for the first layer 20 described herein may be similar to those described in European Patent Specification EP157432881, filed Feb. 25, 2005, incorporated herein by reference.

The terms “ethylene vinyl alcohol copolymer” or “EVOH” as used herein, refers to copolymers comprised of repeating units of ethylene and vinyl alcohol. Ethylene vinyl alcohol copolymers may be represented by the general formula: [(CH₂—CH₂)ₙ—(CH₂—CH(OH))ₘ]. Ethylene vinyl alcohol copolymers may include saponified or hydrolyzed ethylene vinyl acetate copolymers. EVOH refers to a vinyl alcohol copolymer having an ethylene co-monomer and prepared by, for example, hydrolysis of vinyl acetate copolymers or by chemical reactions with vinyl alcohol. Ethylene vinyl alcohol copolymers may comprise from 28 mole percent (or less) to 48 mole percent (or greater) ethylene.

The terms “polyester” or “PET” as used herein, refers to a homopolymer or copolymer having an ester linkage between monomer units. Polyesters may include a homopolymer or copolymer of alkyl-aromatic esters, including but not limited to polyethylene terephthalate (PET), amorphous polyethylene terephthalate (APET), polyethylene furanoate (PEF), glycol-modified polyethylene terephthalate (PETG), and polybutylene terephthalate (PBT); a copolymer of terephthalate and isophthalate including but not limited to polyethylene terephthalate/isophthalate copolymer, such as isophthalic acid (IPA) (modified polyethylene terephthalate (PETI)); a homopolymer or copolymer of aliphatic esters including but not limited to polylactic acid (PLA), polyglycolic acid (PGA); polyhydroxyalkonates including but not limited to polyhydroxypropionate, poly(3-hydroxybutyrate) (PH3B), poly(3-hydroxyvalerate) (PH3V), poly(4-hydroxybutyrate) (PH48), poly(4-hydroxyvalerate) (PH4V), poly(5-hydroxyvalerate) (PH5V), poly(6-hydroxydodecanoate) (PH6D); and blends of any of these materials. The first layer 20 may comprise at least 5, 10, 20, 30, 40, 50, 60, 70, 80, 90, or even 100 percent polyester.

The first layer 20 can alternatively be an abuse resistance layer, bulk layer, odor or oxygen scavenging layer, or provide any other desired property for the end-use of the multilayer film 10. The first layer 20 may be composed of various materials that may include, but are not limited to plastics, papers, or non-woven materials. In some instances, the first layer 20 may be an oriented plastic film, such as for example films of, oriented polyester, oriented polyamide, oriented polypropylene, or oriented polyethylene. The term “oriented” as used herein, refers to a film, sheet, web, etc. that has been elongated in at least one of the machine direction or the transverse direction. Such elongation is accomplished by procedures known in the art. Non-limiting examples of such procedures include the single bubble blown film extrusion process and the slot case sheet extrusion process with subsequent stretching, for example, by tentering, to provide orientation. Another example of such procedure is the trapped bubble or double bubble process; see, for example, U.S. Pat. Nos. 3,546,044 and 6,511,688, each of which is incorporated in its entirety in this application by this reference. In the trapped bubble is or double bubble process, an extruded primary tube leaving the tubular extrusion die is cooled, collapsed and then oriented by reheating, reinflating to form a secondary bubble and recooling. Transverse direction orientation may be accomplished by inflation, radially expanding the heated film tube. Machine direction orientation may be accomplished by the use of nip rolls rotating at different speeds, pulling or drawing the film tube in the machine direction. The combination of elongation at elevated temperature followed by cooling causes an alignment of the polymer chains to a more parallel configuration, thereby improving the mechanical properties of the film, sheet, web, package, etc. Upon subsequent heating of an unrestrained, unannealed, oriented article to its orientation temperature, heat-shrinkage (as measured in accordance with ASTM Test Method D2732, “Standard Test Method for Unrestrained Linear Thermal Shrinkage of Plastic Film and Sheeting,” which is incorporated in its entirety in this application by this reference) may be produced. Heat-shrinkage may be reduced if the oriented article is first annealed or heat-set by heating to an elevated temperature, preferably to an elevated temperature which is above the glass transition temperature and below the crystalline melting point of the polymer comprising the article. This reheating/annealing/heat-setting step also provides a polymeric web of uniform flat width. The polymeric web may be annealed (i.e., heated to an elevated temperature) either in-line with (and subsequent to) or off-line (and in another process) from the orientation process.

The thickness of the first layer 20 may be approximately of from 7.6 microns to 76.2 microns (0.30 mil to 3.0 mil).

Second Layer

The second layer 30 is adapted to seal to itself or another polyolefin material and may be referred to as a sealant layer as is generally known in the art. The term “polyolefin” as used herein, refers to homopolymers or copolymers, including e.g. bipolymers, terpolymers, etc., having a methylene linkage between monomer units which may be formed by any method known to those skill in the art. Suitable examples of polyolefins include polyethylene, low density polyethylene, linear low density polyethylene, very low density polyethylene, ultra-low density polyethylene, medium density polyethylene, high density polyethylene, ethylene/propylene copolymers, polypropylene, propylene/ethylene copolymer, polyisoprene, polybutylene, polybutene, ionomers and the like.

With reference to FIG. 1, the second layer 30 includes a first sublayer 50 and a second sublayer 60. The second layer 30 may be a coextrusion of the first sublayer 50 and the second sublayer 60. The terms “coextruded”, “coextrude”, or “coextrusion” as used herein, refer to the process of extruding two or more polymer materials through a single die with two or more orifices arranged so that the extrudates merge and weld together into a laminar structure before chilling (i.e., quenching). Coextrusion methods known in the art include, but are not limited to blown film coextrusion, slot cast coextrusion and extrusion coating. The flat die or slot cast process includes extruding polymer streams through a flat or slot die onto a chilled roll and subsequently winding the film onto a core to form a roll of film for further processing.

The term “blown film” as used herein, refers to a film produced by the blown coextrusion process. In the blown coextrusion process, streams of melt-plastified polymers are forced through an annular die having a central mandrel to form a tubular extrudate. The tubular extrudate may be expanded to a desired wall thickness by a volume of fluid (e.g., air or other gas) entering the hollow interior of the extrudate via the mandrel and then rapidly cooled or quenched by any of various methods known in the art.

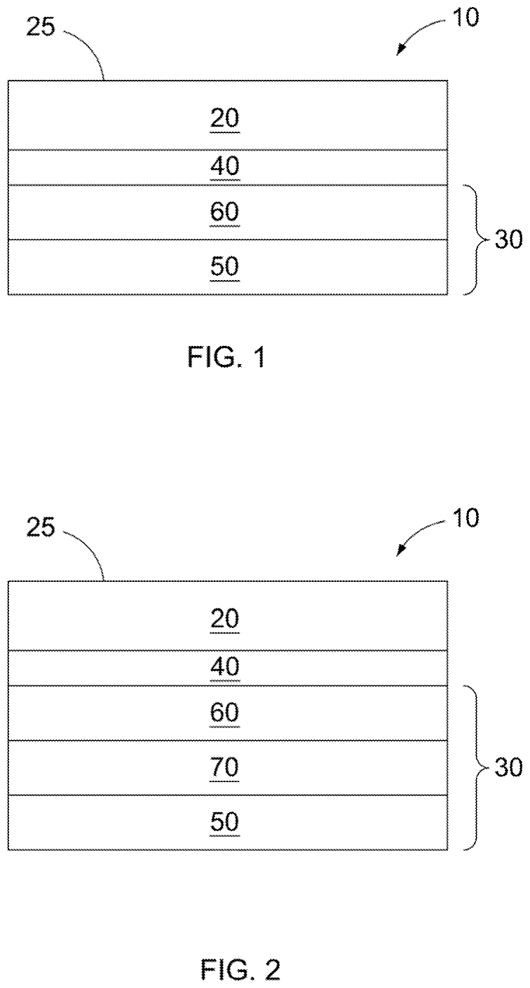

The first sublayer 50 and the second sublayer 60 may be coextruded such that the first sublayer 50 and the second sublayer 60 are adjacent to each other as shown in FIG. 1. The terms “adjacent” or “directly adjacent” as used herein, refers to the lack of an intervening material between the components. The first sublayer 50 and the second sublayer 60 may be coextruded such that the first sublayer 50 and the second sublayer 60 are not adjacent to each other as shown in FIG. 2. The term “non-adjacent” as used herein, refers to an intervening material positioned between the components. For example, the second layer 30 shown in FIG. 2 includes an intervening layer 70 that is between the first sublayer 50 and the second sublayer 60. It should be understood that the second layer 30 may not include the intervening layer 70 or may include as many intervening layers 70 as necessary to arrive at the desired thickness, performance or other desired properties of the multilayer film 10. The second layer 30 may include no intervening layer 70, one intervening layer 70, two intervening layers 70, three intervening layers 70, four intervening layers 70, five intervening layers 70, six intervening layers 70, seven intervening layers 70, eight intervening layers 70, nine intervening layers 70, ten intervening layers 70, and so on.

The first sublayer 50 includes a polypropylene copolymer, a thermoplastic polyolefin having a modulus of from 10 MPa to less than 1,700 MPa, and an olefin block copolymer. The term “polypropylene copolymer” as used herein, refers to copolymers comprising two types of monomers, between 51 percent and 99 percent by weight of propylene and between 1 percent and 49 percent by weight of another polymer, such as for example, ethylene, relative to the total weight of the polypropylene copolymer. The polypropylene copolymer may be present in the first sublayer 50 in an amount from 20 percent to 80 percent, 25 percent to 60 percent, 30 percent to 50 percent, and even more specifically 35 percent to 40 percent, by weight relative to the first sublayer 50.

It should be understood that the polypropylene copolymers referred to herein may include impact, random, block and/or grafted copolymers, and may include more than two repeating components wherein the dominant monomer is propylene. Those skilled in the art will appreciate that polypropylene copolymers are distinctly different than propylene homopolymers that do not include a different monomer other than propylene and are also distinctly different than polyethylene copolymers. Non-limiting, commercially available examples of the polypropylene copolymer include 1) random polypropylene copolymers such as PRO-FAX SA861 random polypropylene available from LyondellBasell, Houston, Tex., USA, and BRASKEM RP 650 random polypropylene available from Braskem America Inc., Philadelphia, Pa., USA; 2) amorphous polypropylenelethylene copolymers such as EASTOFLEX E1060PL, available from Eastman Chemical Company, Inc., Kingsport, Tenn., USA; 3) olefin block copolymers such as INFUSE 9010 or 9530 available from The Dow Chemical Company, Inc., Midland, Mich., USA; and 4) heterophasic polypropylene copolymers or polypropylene impact copolymers such as INSPIRE 114 Performance Polymer EU available from Braskem America Inc., or Polypropylene 4170 Impact Copolymer available from Total Petrochemicals USA, Inc., Houston, Tex., USA. The first sublayer 50 includes a propylene-based random copolymer that may be present in an amount of from 10 percent to 60 percent, 10 percent to 70 percent, or perhaps 10 percent to 80 percent by weight relative to the first sublayer 50. The first sublayer 50 includes an olefin block copolymer that may be present in an amount of from 10 percent to 40 percent, 10 percent to 50 percent, or perhaps 10 percent to 60 percent by weight relative to the first sublayer 50. It should be understood that the first sublayer 50 is essentially free of polypropylene homopolymer.

The first sublayer 50 additionally includes a thermoplastic polyolefin having a flexural modulus of from 10 MPa to less than 1,700 MPa as measured according to ISO 178. The term “thermoplastic polyolefin” as used herein, refers to a polyolefin-based polymer. For example, the flexural modulus may be 10 MPa, 20 MPa, 30 MPa, 40 MPa, 50 MPa, 60 MPa, 70 MPa, 80 MPa, 90 MPa, 100 MPa, 200 MPa, 300 MPa, 400 MPa, 500 MPa, 600 MPa, 700 MPa, 800 MPa, 900 MPa, 1,000 MPa, 1,100 MPa, 1,200 MPa, 1,300 MPa, 1,400 MPa, 1,500 MPa, 1,600 MPa, 1699 MPa, or any value of from 10 MPa to less than 1,700 MPa. The thermoplastic polyolefin may be present in the first sublayer 50 of from an amount from 10 percent to 40 percent, 10 percent to 50 percent, or perhaps 10 percent to 60 percent by weight relative to the first sublayer 50. Suitable thermoplastic polyolefins that are sometimes referred to as plastomers, may include elastomeric thermoplastic polyolefins such as, but not limited to VISTAMAXX Exact 3139 available from ExxonMobil, Houston, Tex., USA; THERMORUN 3555B or 3755B/N and ZELAS R-TPO, available from Mitsubishi Chemical Corporation, Tokyo, Japan; ADFLEX Q 100 F or Q 300 f and SOFTELL, CA 02 A, available from Lyondell Basell, Houston, Tex., USA; and VERSIFY 2000 or 3000, available from The Dow Chemical Company.

The second sublayer 60 includes a polypropylene homopolymer or a polypropylene copolymer. Suitable polypropylene homopolymers include ExxonMobil 9054, available from ExxonMobil, Baytown, Tex., USA; and INSPIRE 6021N, 6025N or 6025 available from Braskem America Inc. Exemplary polypropylene copolymers have been previously presented within the discussion regarding suitable polypropylene copolymers for the first sublayer 50. The polypropylene homopolymer or copolymer may be present in an amount of rom 0 percent to 30 percent, 0 percent to 40 percent, 0 percent to 50 percent, or perhaps 0 percent to 60 percent by weight of the second sublayer.

Further, the intervening layer 70 may include, but is not limited to, materials that are also present in the first sublayer 50 and/or the second sublayer 60. Additionally, the total thickness of the first sublayer 50, the second sublayer 60 and the intervening layer 70, or combinations thereof, may be approximately of from 25.4 microns to 127.0 microns (1 mil to 5 mil). The individual layer, the first sublayer 50, the second sublayer 60, or the third sublayer 70, thickness may be approximately of from 5.0 microns to 76.2 microns (0.2 mil to 3.0 mil).

Multilayer Film

The first layer 20 and the second layer 30 may be attached to each other through various laminating methods known in the art to form the multilayer film 10. The term “attached” as used herein, refers to materials adhering two surfaces to one another, such as the planar surfaces of two film layers. The laminating methods include, but are not limited to, thermal lamination, adhesive lamination, extrusion lamination, extrusion coating, and photolytic lamination. In an embodiment, the first layer 20 and the second layer 30 and may be joined by the laminating agent 40. In an embodiment, the laminating agent 40 may be an extrusion laminating agent 40 where the parameters for such lamination are expected to be set by one skilled in the art without undue experimentation. In an embodiment, the first layer 20 and the second layer 30 may be joined by laminating methods known in the art.

In another embodiment, the laminating agent 40 may be an adhesive laminating agent 40. Unless otherwise specifically indicated, an adhesive may have any suitable composition that provides a desired level of adhesion with the one or more surfaces in contact with the adhesive. Adhesives may be solvent-based, water-based (also known as waterborne), or solventless. Solvent-based adhesives include an adhesive and at least one solvent and requires the solvent to be removed by evaporation (e.g., drying) after the solvent-based adhesive is applied. Non-limiting examples of solvent-based adhesives include polyurethane-based adhesives such as two-part polyurethane adhesives, including but not limited to those with solids content greater than 30 percent by weight. A specific non-limiting example of a solvent based adhesive is a two-part adhesive comprising LIOFOL LA PB5210 (a solvent urethane adhesive) and LIOFOL LA PB 500-83 (a solvent urethane co-reactant), having a solids content of 40 percent by weight available from Henkel Corporation, Rocky Hill, Conn., USA. A further specific non-limiting example of a solvent-based adhesive is a two-part adhesive comprising LAMAL HSA (adhesive) and LAMAL C (co-reactant), having a solids content of 32 percent by weight available from The Dow Chemical Company. Another further specific non-limiting example of a solvent-based adhesive is a two-part adhesive comprising ADCOTE 538A (adhesive) and ADCOTE 536B (co-reactant), having a solids content of 40 percent by weight available from The Dow Chemical Company. Another further specific non-limiting example of a solvent-based adhesive is a two-part adhesive comprising ADCOTE 545E (adhesive) and ADCOTE Coreactant CT (co-reactant), having a solids content of 32 percent by weight available from The Dow Chemical Company. A non-limiting example of a laminating adhesive that is a ready-to-use, formaldehyde-free, waterbome adhesive for use in the manufacture of flexible film laminates for food packaging is ROBOND L-90D acrylic adhesive (acrylic-based) available from The Dow Chemical Company. A further non-limiting example of a barrier-type, laminating adhesive is SERFENE 2010 PVdC emulsion available from The Dow Chemical Company. In general, the adhesives have negligible effect on the thickness of the film.

The multilayer film 10 may include a third layer 75 or layers 75 to form a three-layer structure, a four-layer structure, a five-layer structure, etc. With reference to FIG. 3, the multilayer film 10 illustrated in FIG. 1 is shown to include a third layer 75. The third layer 75 may be any of the materials that compose the first layer 20 and appropriate materials as previously described with reference to the first layer 20. For example, in some embodiments, the third layer 75 may include polyamide or a blend of polyamide resins. In another embodiment, the third layer 75 is an oxygen barrier and may include EVOH. In yet another embodiment, the third layer 75 may be an oriented film, such as for example, oriented polyester, oriented polyamide, oriented polypropylene, or oriented polyethylene.

The thickness of the third layer 75 may be approximately of from 7.6 microns to 50.0 microns (0.30 mil to 2.0 mil).

With reference to FIGS. 1 and 3, the third layer 75 is attached to the exterior surface of the first layer 25. The term “exterior surface” as used herein, refers to a surface of the multilayer film 10 that does not have contact with another film surface. The third layer 75 and the first layer 20 may be attached to each other through various laminating methods known in the art, such as thermal lamination, adhesive lamination, extrusion lamination, extrusion coating, and photolytic lamination.

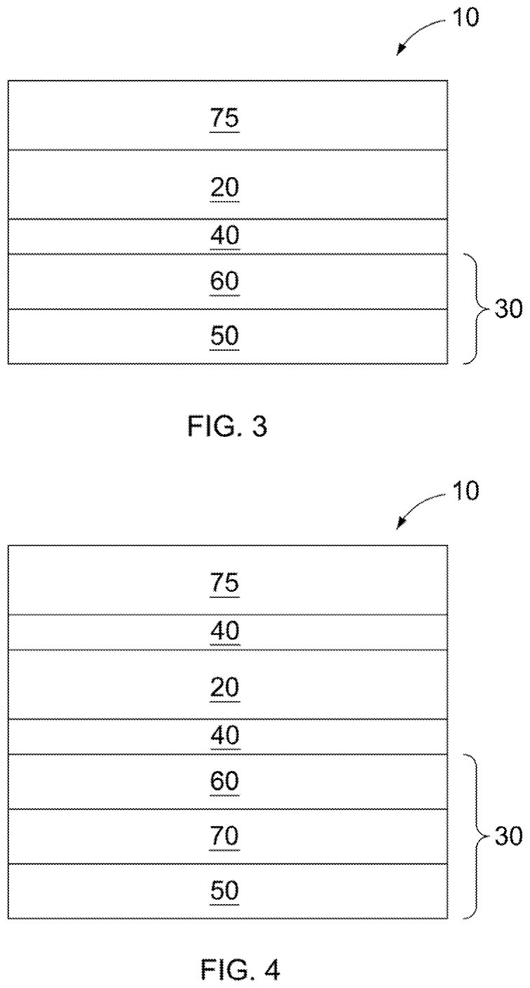

With reference to FIG. 4, another embodiment of the multilayer film 10 is shown to include the third layer 75 adhesively attached to the exterior surface of the first layer 25 with an adhesive layer 40. The multilayer film 10 also includes an intervening layer 70 between the first sublayer 50 and the second sublayer 60 of the second layer 20.

Multilayer Film Package

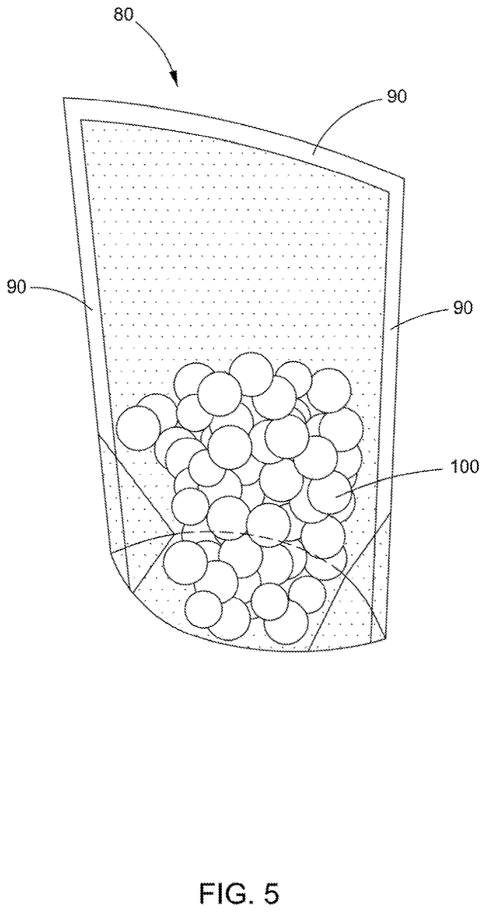

With reference to FIG. 5, the multilayer film 10 may be fabricated into a package 80. The package 80 may be formed by a form-fill-seal process or by a pouching process as generally known in the art. The package 80 that is shown in FIG. 5 is a stand-up pouch having seals 90. The package 80 can enclose a product 100 that may be, but is not limited to, any type of consumer or industrial item, medical product, pharmaceutical item, or food item. The multilayer film 10 can be formed into a package 80 that includes hermetic seals 90. The term “hermetic seal” as used herein, refers to a seal 90 that is maintained against the flow of air or fluid; an airtight or liquid proof seal. The seal 90 may be formed by any known method including heat sealing, ultrasonic sealing. RF welding, etc. In an embodiment, the multilayer film 10 may be heat sealed to itself (first sublayer 50 to first sublayer 50), at a temperature within a range of from 127 degrees Celsius to 221 degrees Celsius, or 148 degrees Celsius to 204 degrees Celsius, or alternatively 168 degrees Celsius to 185 degrees Celsius, under 0.28 MPa (40 psi) with a dwell time of 1 second with the use of heat-seal equipment and methods generally known in the packaging art. The peak seal strength is of from about 1.40 N/mm (8.0 lb/in) to about 20.00 N/mm (114.2 lb/in) as measured using ASTM F88/F88M. The multilayer film 10 may be ultrasonically sealed with an energy within a range of from 46 Joules to 164 Joules. In another embodiment, the multilayer film 10 may be ultrasonically sealed to itself with an energy of 50 Joules with exposure to the energy within a range of from 50 milliseconds to 200 milliseconds, and where an ultrasonic horn is vibrating within a range from 20 KHz and 40 KHz with the use of rotary ultrasonic equipment and methods as generally known in the packaging art. The peak seal strength is of from about 4.00 N/mm (22.8 lb/in) to about 20.00 N/mm (114.2 lb/in) as measured using ASTM F88/F88M. In any embodiment, the multilayer film 10 has a seal initiation temperature of from greater than 105 degrees Celsius to 180 degrees Celsius. For example, the seal initiation temperature may be 106 degrees Celsius, 110 degrees Celsius, 120 degrees Celsius, 130 degrees Celsius, 140 degrees Celsius, 150 degrees Celsius, or even greater. It should be understood that the seal initiation temperature may differ for any given application. For example, in one application, the multilayer film 10 may be used for a package that may require a seal strength of 1.40 N/mm when heat sealed. In another application, the multilayer film 10 may be used for a package that may require a seal strength of 4.00 N/mm when ultrasonically sealed. The seal initiation temperature can also be impacted by the type of seal that is formed, for example a fin seal versus another type of seal as generally known in the art.

In an embodiment, the multilayer film 10 includes a first layer 20 that includes an oriented polyester film. The multilayer film 10 also includes a second layer 30 that includes a first sublayer 50 that includes 1) a propylene-based random copolymer in an amount of from 10 percent to 80 percent by weight of the first sublayer 50, 2) a thermoplastic polyolefin having a modulus of less than 1,700 MPa in an amount of from 10 percent to 40 percent by weight of the first sublayer 50, 3) and an olefin block copolymer in an amount of from 10 percent to 50 percent by weight of the first sublayer 50. The second layer 30 also includes a second sublayer 60 that includes polypropylene homopolymer or polypropylene copolymer. The second layer 30 is a coextrusion of the first sublayer 50 and the second sublayer 60. An adhesive laminating agent 40 of polyurethane adhesive is positioned between the first layer 50 and the second layer 60. The multilayer film 10 further includes a third layer 75 that includes a barrier film of ethylene vinyl alcohol copolymer that is positioned exterior to the first layer 50. The multilayer film 10 includes a seal initiation temperature that is greater than 105 degrees Celsius. The multilayer film 10 has a peak seal strength of from 1.40 N/mm to 20.00 N/mm when heat sealed to itself (first sublayer 50 to first sublayer 50) at a temperature within a range from 127 degrees Celsius to 221 degrees Celsius. The multilayer film 10 has a peak seal strength of from 4.00 N/mm to 20.00 N/mm when ultrasonically sealed to itself with an energy within a range of from 46 Joules to 164 Joules. The multilayer film 10 is adapted to withstand exposure to heat pasteurization of greater than 70 degrees Celsius. The multilayer film 10 can further be formed into a hermetically sealed package.

### EXAMPLES

Each of the examples had a structure as illustrated in FIG. 4. The first sublayer 50, the second sublayer 60 and an intervening layer 70 were coextruded together using a blown film method to form the second layer 30. Each of the examples differs in the composition of the second layer 30. The coextruded second layer 30 was then adhesively laminated to a first layer 20 that was a biaxially oriented polyamide film having a thickness of 15 microns (0.60 mil). A third layer 75 was further adhesively laminated to the exterior surface of the first layer 25. The third layer was an aluminum oxide coated, oriented polyester film having a thickness of 12 microns (0.48 mil). The first layer 20, the second layer 30, and the third layer 75, in all Examples, were adhesively laminated using a polyurethane-based adhesive applied at a dry weight of 2.3 lb/ream (3.74 g/m²).

### Example 1

The first sublayer 50 composition included:
a random copolymer;
a thermoplastic polyolefin having low modulus;
a block copolymer; and
processing additives, as is generally known in the art.

The second sublayer 60 composition included:
a polypropylene impact copolymer;
a thermoplastic polyolefin having low modulus; and
a polypropylene homopolymer.

The intervening layer 70 composition included:
a polypropylene impact copolymer;
a thermoplastic polyolefin having low; and
a polypropylene homopolymer.

### Example 2

The first sublayer 50 composition included:
a random copolymer;
a thermoplastic polyolefin having low modulus;
a block copolymer; and
processing additives, as is generally known in the art.

The second sublayer 60 composition included:
a polypropylene impact copolymer;
a thermoplastic polyolefin having low modulus; and
a polypropylene homopolymer.

The intervening layer 70 composition included:
a random copolymer;
a thermoplastic polyolefin having low modulus; and
a block copolymer.

### Example 3

The first sublayer 50 composition included:
a polypropylene impact copolymer;
a thermoplastic polyolefin having low modulus;
a block copolymer; and
processing additives, as is generally known in the art.

The second sublayer 60 composition included:
a polypropylene impact copolymer;
a thermoplastic polyolefin having low modulus; and
a polypropylene homopolymer.

The intervening layer 70 composition included:
a polypropylene impact copolymer;
a thermoplastic polyolefin having low modulus; and
a polypropylene homopolymer.

### Example 4

The first sublayer 50 composition included:
a random copolymer;
a thermoplastic polyolefin having low modulus; and
a block copolymer.
processing additives, as is generally known in the art.

The second sublayer 60 composition included:
a polypropylene impact copolymer;
a thermoplastic polyolefin having low modulus; and
a polypropylene homopolymer.

The intervening layer 70 composition included:
a polypropylene impact copolymer;
a thermoplastic polyolefin having low modulus; and
a polypropylene homopolymer.

### Comparative Example 1

The first sublayer 50 composition included:
a polypropylene impact copolymer;
a thermoplastic polyolefin having low modulus; and
a polypropylene homopolymer relative to the first sublayer 50.

The second sublayer 60 composition included:
a polypropylene impact copolymer;
a thermoplastic polyolefin having low modulus; and
a polypropylene homopolymer.

The intervening layer 70 composition included:
a polypropylene impact copolymer;
a thermoplastic polyolefin having low modulus; and
a polypropylene homopolymer.

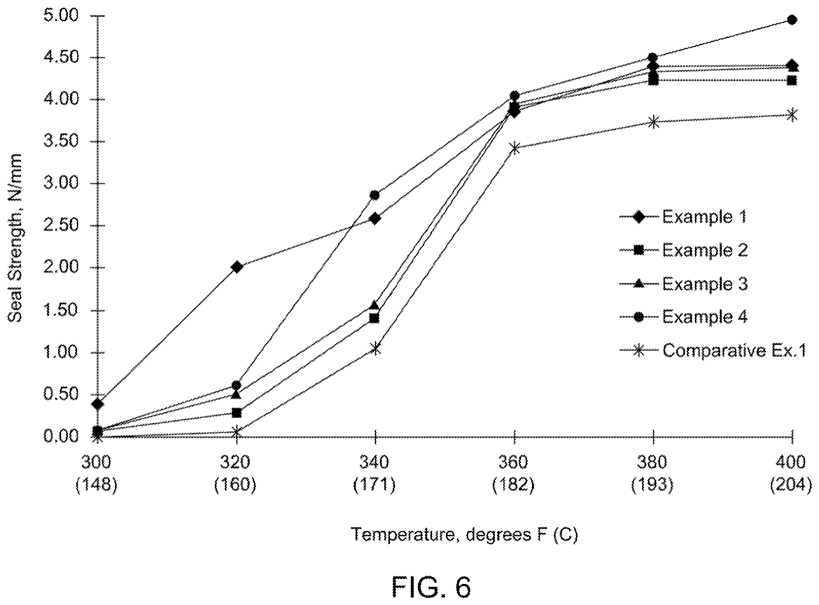

To demonstrate the heat seal strengths, the film was heat sealed to itself (first sublayer 50 to first sublayer 50) at different temperatures, from 148 degrees Celsius to 204 degrees Celsius (300 degrees Fahrenheit to 400 degrees Fahrenheit) under 0.28 MPa (40 psi) and a 0.5 second dwell time and allowed to cool to ambient temperature. The force required to delaminate the films at the heat seal at a 90 degree angle was measured using an Instron Tensile Tester and test method ASTM F88/F88M. Results are shown as N/mm in TABLE 1 below and are represented in the chart illustrated in FIG. 6.

TABLE 1

| | 148° C. | 160° C. | 171° C. | 182° C. | 193° C. | 204° C. |
|---|---|---|---|---|---|---|
| | (300° F.) | (320° F.) | (340° F.) | (360° F.) | (380° F.) | (400° F.) |
| Example 1 | 0.29 | 1.99 | 2.76 | 3.94 | 4.35 | 4.22 |
| | 0.23 | 1.60 | 1.89 | 3.64 | 4.40 | 4.47 |
| | 0.67 | 2.45 | 3.12 | 3.99 | 4.40 | 4.52 |
| Average | 0.39 | 2.01 | 2.59 | 3.86 | 4.39 | 4.40 |
| Example 2 | 0.07 | 0.30 | 1.39 | 4.09 | 3.98 | 4.36 |
| | 0.10 | 0.33 | 1.41 | 3.96 | 4.26 | 4.00 |
| | 0.03 | 0.20 | 1.42 | 3.69 | 4.47 | 4.32 |
| Average | 0.07 | 0.28 | 1.41 | 3.91 | 4.23 | 4.23 |
| Example 3 | 0.03 | 0.83 | 1.62 | 3.97 | 4.51 | 4.30 |
| | 0.06 | 0.40 | 1.43 | 3.82 | 4.34 | 4.46 |
| | 0.11 | 0.29 | 1.66 | 4.07 | 4.17 | 4.42 |
| Average | 0.07 | 0.51 | 1.57 | 3.95 | 4.34 | 4.39 |
| Example 4 | 0.03 | 0.55 | 3.13 | 3.90 | 4.53 | 4.82 |
| | 0.06 | 0.20 | 2.80 | 4.13 | 4.48 | 5.08 |
| | 0.14 | 0.99 | 2.66 | 4.08 | 4.50 | 4.90 |
| Average | 0.08 | 0.58 | 2.87 | 4.04 | 4.50 | 4.93 |
| Comparative | 0.01 | 0.10 | 1.15 | 3.50 | 3.71 | 3.90 |
| Example 1 | | | | | | |
| | 0.01 | 0.06 | 1.29 | 3.40 | 3.75 | 3.75 |
| | 0.02 | 0.03 | 0.67 | 3.38 | 3.75 | 3.83 |
| Average | 0.01 | 0.06 | 1.04 | 3.43 | 3.74 | 3.82 |

It can be seen from the results in TABLE 1 and FIG. 6 that the multilayer films have heat seal strength greater than 1.40 N/mm when sealed at seal temperatures from 155 degrees Celsius to 204 degrees Celsius. Comparative Example 1 does not attain a heat seal strength of 1.40 N/mm or greater until sealed at temperatures greater than 155 degrees Celsius.

To demonstrate the ultrasonic seal strength, the film was ultrasonically sealed to itself (first sublayer 50 to first sublayer 50). The films were ultrasonically sealed using a 30 KHz Herrmann ultrasonic unit (Herrmann Ultrasonics, Bartlet, Ill., USA) with a DDc generator. A range of energy levels between 46 Joules and 164 Joules was used. At each energy level, a range of amplitude between 59 percent and 110 percent, with a hold amplitude of 85 percent, and weld forces of from 200 N to 750 N were used.

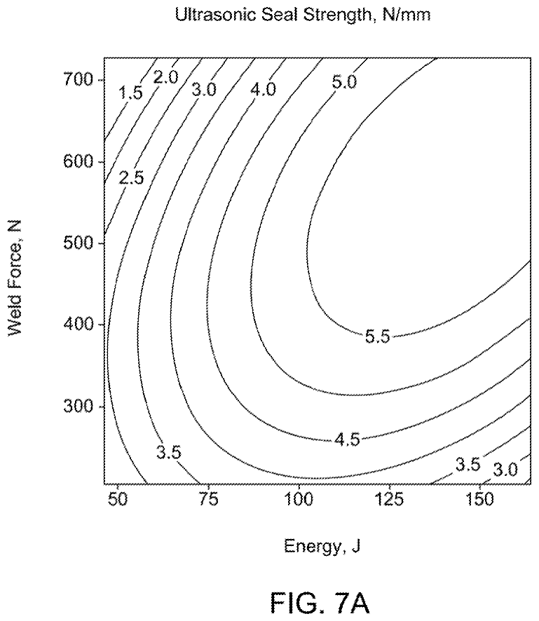

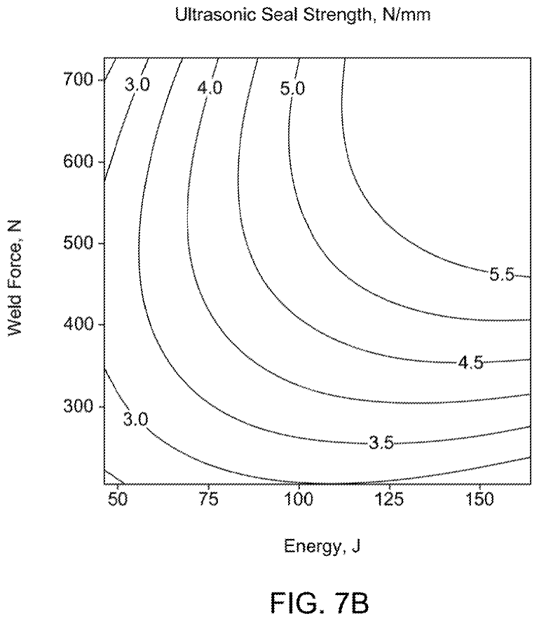

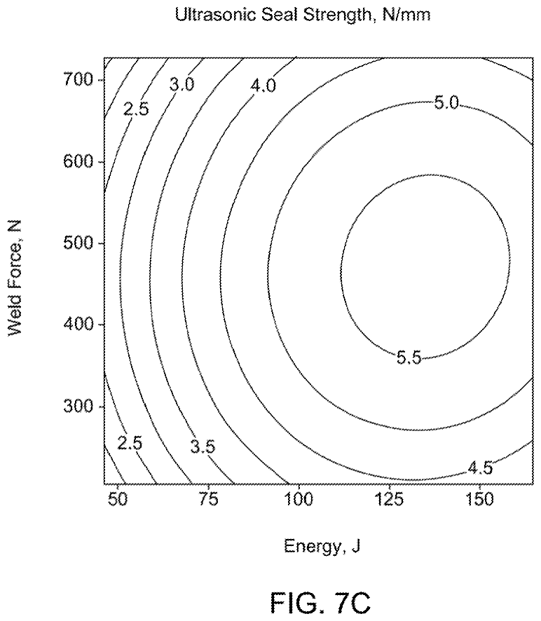

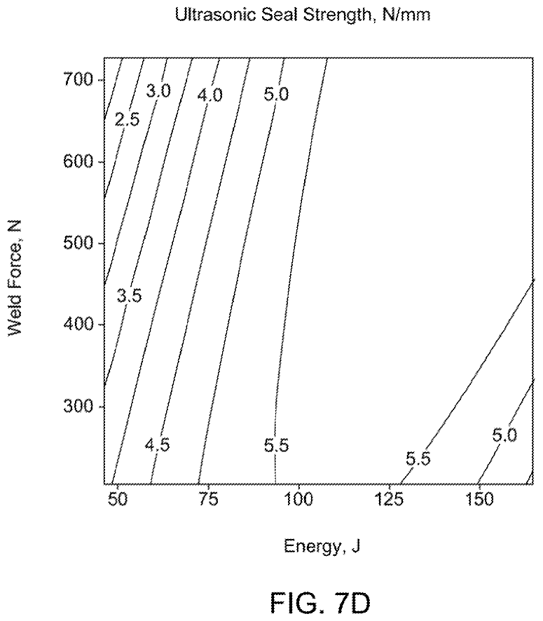

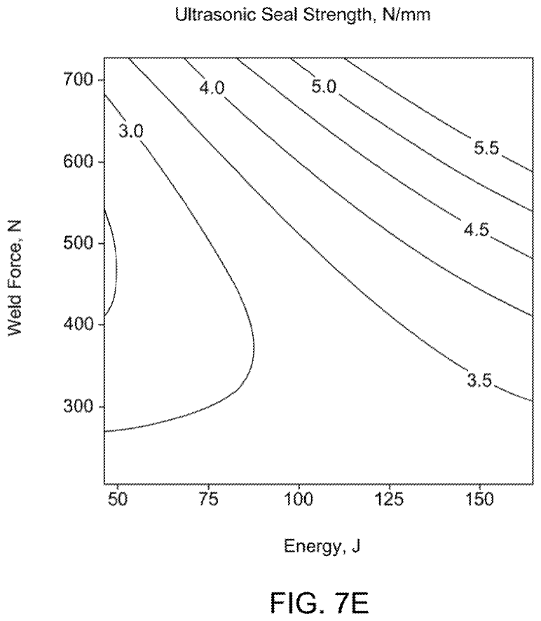

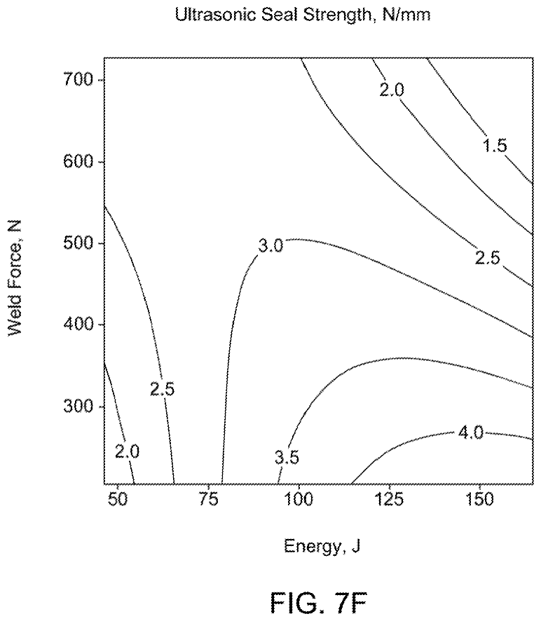

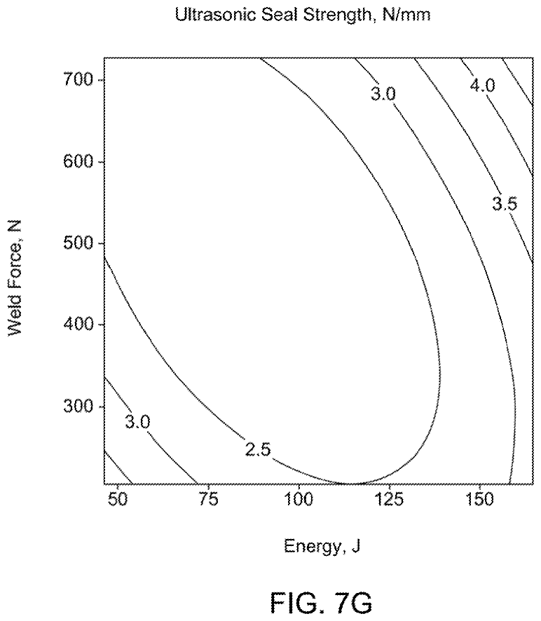

The force required to delaminate the films at the ultrasonic seal at a 90 degree angle was measured using an Instron Tensile Tester using test method ASTM F88/F88M. Comparative Example 2 and Comparative Example 3 were further evaluated for ultrasonic seal strength. The ultrasonic seal strength data is represented in graphs that are illustrated in FIGS. 7A-7G. The graphs demonstrate results at 85 percent amplitude, although data was collected at the amplitudes previously described. FIG. 7A represents the ultrasonic seal strength of the Example 1 material; FIG. 78 represents the ultrasonic seal strength of the Example 2 material; FIG. 7C represents the ultrasonic seal strength of the Example 3 material; FIG. 7D represents the ultrasonic seal strength of the Example 4 material; FIG. 7E represents the ultrasonic seal strength of the Comparative Example 1 material; FIG. 7F represents the ultrasonic seal strength of the Comparative Example 2 material: and FIG. 7G represents the ultrasonic seal strength of the Comparative Example 3 material. The structure and compositions of Comparative Examples 2 and 3 are described below:

### Comparative Example 2

The first sublayer 50 composition included:
a heterophasic polypropylene copolymer
a polypropylene plastomer
a polypropylene homopolymer
processing additives, as is generally known in the art.

The second sublayer 60 composition included:
a heterophasic polypropylene copolymer
a polypropylene plastomer
a polypropylene homopolymer.

The intervening layer 70 composition included:
a heterophasic polypropylene copolymer
a polypropylene plastomer
a polypropylene homopolymer pigmented white with titanium dioxide.

Comparative Example 3 included a polypropylene film, TORAYFAN RT42, available from Toray Plastics (America), Inc., North Kingstown, R.I., USA.

It can be seen in FIGS. 7A-7D that the multilayer films have seal strengths greater than 4.00 N/mm when sealed ultrasonically at an energy of at least 46 Joules to 80 Joules with relatively low weld forces, for example, weld forces equal to or less than 420 N.

It can be seen in FIGS. 7E-7G that the Comparative Examples 1-3 do not attain seal strengths of 0.00 N/mm or greater unless much higher weld forces and/or energies are used than those of Examples 1-4.

The design of experiment is shown in TABLE 2 and the data for the ultrasonic seal strengths is shown in TABLES 3 and 4.

TABLE 2

| | | | | | Weld | |
|---|---|---|---|---|---|---|
| Standard | Run | Pt | | Energy | Force | |
| Order | Order | Type | Blocks | (J) | (N) | Amplitude |
| 16 | 1 | 0 | 1 | 105.00 | 467.06 | 85.00 |
| 20 | 2 | 0 | 1 | 105.00 | 467.06 | 85.00 |
| 3 | 3 | 1 | 1 | 70.00 | 622.75 | 70.00 |
| 7 | 4 | 1 | 1 | 70.00 | 622.75 | 100.00 |
| 1 | 5 | 1 | 1 | 70.00 | 311.38 | 70.00 |
| 6 | 6 | 1 | 1 | 140.00 | 311.38 | 100.00 |
| 8 | 7 | 1 | 1 | 140.00 | 622.75 | 100.00 |
| 12 | 8 | −1 | 1 | 105.00 | 728.88 | 85.00 |
| 18 | 9 | 0 | 1 | 105.00 | 467.06 | 85.00 |
| 4 | 10 | 1 | 1 | 140.00 | 622.75 | 70.00 |
| 17 | 11 | 0 | 1 | 105.00 | 467.06 | 85.00 |
| 11 | 12 | −1 | 1 | 105.00 | 205.24 | 85.00 |
| 19 | 13 | 0 | 1 | 105.00 | 467.06 | 85.00 |
| 15 | 14 | 0 | 1 | 105.00 | 467.05 | 85.00 |
| 9 | 15 | −1 | 1 | 46.14 | 467.06 | 85.00 |
| 10 | 16 | −1 | 1 | 163.86 | 467.06 | 85.00 |
| 5 | 17 | 1 | 1 | 70.00 | 311.38 | 100.00 |
| 13 | 18 | −1 | 1 | 105.00 | 467.06 | 59.77 |
| 2 | 19 | 1 | 1 | 140.00 | 311.38 | 70.00 |
| 14 | 20 | −1 | 1 | 105.00 | 467.06 | 110.23 |

TABLE 3

| Standard | Example 1 | Example 2 | Example 3 | Example 4 |
|---|---|---|---|---|
| Order | (N/mm) | (N/mm) | (N/mm) | (N/mm) |
| 16 | 6.30 | 5.20 | 5.97 | 5.62 |
| 20 | 5.75 | 4.96 | 4.91 | 5.76 |
| 3 | 3.36 | 5.67 | 4.03 | 4.61 |
| 7 | 1.90 | 2.84 | 3.35 | 2.66 |
| 1 | 4.60 | 3.59 | 4.08 | 5.32 |
| 6 | 4.88 | 3.22 | 5.72 | 5.76 |
| 8 | 5.85 | 6.61 | 5.31 | 6.32 |
| 12 | 5.42 | 5.72 | 4.89 | 5.92 |
| 18 | 6.02 | 4.24 | 5.71 | 6.04 |
| 4 | 6.29 | 6.33 | 5.79 | 6.27 |
| 17 | 5.50 | 5.09 | 5.83 | 5.97 |
| 11 | 3.73 | 2.91 | 3.61 | 5.74 |
| 19 | 5.11 | 4.57 | 5.43 | 5.83 |
| 15 | 5.94 | 6.46 | 5.84 | 6.21 |
| 9 | 3.93 | 3.21 | 2.92 | 3.48 |
| 10 | 5.00 | 5.97 | 5.30 | 5.57 |
| 5 | 3.08 | 4.24 | 4.55 | 4.08 |
| 13 | 5.86 | 6.08 | 5.81 | 6.00 |
| 2 | 5.60 | 5.66 | 6.28 | 5.90 |
| 14 | 5.53 | 5.28 | 6.11 | 5.29 |

TABLE 4

| | Comparative | Comparative | Comparative |
|---|---|---|---|
| Standard | Example 1 | Example 2 | Example 3 |
| Order | (N/mm) | (N/mm) | (N/mm) |
| 16 | 4.57 | 1.56 | 3.54 |
| 20 | 3.33 | 2.21 | 1.88 |
| 3 | 3.23 | 3.43 | 1.62 |
| 7 | 4.85 | 2.04 | 3.01 |
| 1 | 3.35 | 3.40 | 1.67 |
| 6 | 3.09 | 4.21 | 2.43 |
| 8 | 5.19 | 2.24 | 3.10 |
| 12 | 3.06 | 3.55 | 2.16 |
| 18 | 1.94 | 3.28 | 2.44 |
| 4 | 3.23 | 3.06 | 2.45 |
| 17 | 3.06 | 4.11 | 2.99 |
| 11 | 3.73 | 2.91 | 2.75 |
| 19 | 3.55 | 4.37 | 2.87 |
| 15 | 2.64 | 1.81 | 2.42 |
| 9 | 4.02 | 3.37 | 2.24 |
| 10 | 3.12 | 2.79 | 3.05 |
| 5 | 2.72 | 2.20 | 2.47 |
| 13 | 2.36 | 2.88 | 2.08 |
| 2 | 3.60 | 2.87 | 1.52 |
| 14 | 3.31 | 1.88 | 1.92 |

Each and every document cited in this present application, including any cross referenced or related patent or application, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

Unless otherwise indicated, all numbers expressing sizes, amounts, ranges, limits, and physical and other properties used in the present application are to be understood as being preceded in all instances by the term “about”. Accordingly, unless expressly indicated to the contrary, the numerical parameters set forth in the present application are approximations that can vary depending on the desired properties sought to be obtained by a person of ordinary skill in the art without undue experimentation using the teachings disclosed in the present application.

The description, examples, embodiments, and drawings disclosed are illustrative only and should not be interpreted as limiting. The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Modifications and other embodiments will be apparent to a person of ordinary skill in the packaging arts, and all such modifications and other embodiments are intended and deemed to be within the scope of the present invention.

1. A multilayer film comprising:
a) a first layer,
b) a second layer comprising:
i) a first sublayer comprising,
a. a polypropylene copolymer,
b. a thermoplastic polyolefin having a modulus of less than 1,700 MPa, and
c. olefin block copolymer,
ii) a second sublayer comprising polypropylene homopolymer or polypropylene copolymer, and
c) a laminating agent positioned between the first layer and the second layer wherein the multilayer film has a seal initiation temperature of greater than 105 degrees Celsius.

2. The multilayer film of claim 1, wherein the thermoplastic polyolefin has a modulus from 10 MPa to less than 1,700 MPa.

3. The multilayer film according to claim 1, wherein the multilayer film has a seal initiation temperature from greater than 105 degrees Celsius to 180 degrees Celsius.

4. The multilayer film according to claim 1, wherein the second layer comprises a coextrusion of the first sublayer and the second sublayer.

5. The multilayer film according to claim 1, wherein the second layer comprises a blown film or a cast film.

6. The multilayer film according to claim 1, wherein the first layer comprises a first oriented film comprising oriented polyester, oriented polyamide, oriented polypropylene, or oriented polyethylene.

7. The multilayer film according to claim 1, wherein the first layer comprises a first barrier film comprising polyamide, ethylene vinyl alcohol copolymer, polyvinyl chloride, glass, thermoplastic polyurethane, polyester, or blends or coextrusions thereof, or aluminum foil, aluminum oxide coated polyester, or other barrier coatings.

8. The multilayer film according to claim 1, wherein the laminating agent comprises adhesive comprising a polyurethane-based adhesive.

9. The multilayer film according to claim 1, wherein the multilayer film further comprises a third layer comprising a second oriented film wherein the third layer is positioned exterior to the first layer.

10. The multilayer film according to claim 1, wherein the multilayer film further comprises a third layer comprising a second barrier film wherein the third layer is positioned exterior to the first layer.

11. The multilayer film according to claim 1, wherein the second sublayer comprises polypropylene homopolymer in an amount from 0 to 50 percent by weight of the second sublayer.

12. The multilayer film according to claim 1, wherein the first sublayer comprises the thermoplastic polyolefin having a modulus of less than 1,700 MPa in an amount from 10 to 60 percent by weight of the first sublayer.

13. The multilayer film according to claim 1, wherein the multilayer film has a peak seal strength from greater than 1.40 N/mm to 20.00 N/mm when sealed at a seal temperature from 127 degrees Celsius to 221 degrees Celsius.

14. The multilayer film according to claim 1, wherein the multilayer film has a peak seal strength from greater than 4.00 N/mm to 20.00 N/mm when sealed ultrasonically at an energy of at least 50 Joules.

15. The multilayer film according to claim 1, wherein the first sublayer is essentially free of polypropylene homopolymer.

16. A multilayer film comprising:
a) a first layer comprising an oriented film comprising polyamide,
b) a second layer comprising:
i) a first sublayer comprising,
a. a propylene-based random copolymer in an amount from 10 to 80 percent by weight relative of the first sublayer,
b. a thermoplastic polyolefin having a modulus of less than 1,700 MPa in an amount from 10 to 40 percent by weight relative of the first sublayer,
c. olefin block copolymer in an amount from 10 to 50 percent by weight relative of the first sublayer,
ii) a second sublayer comprising polypropylene homopolymer or polypropylene copolymer, and
c) a laminating agent positioned between the first layer and the second layer; and
d) a third layer comprising a barrier film comprising ethylene vinyl alcohol copolymer wherein the third layer is positioned exterior to the first layer,
wherein the second layer comprises a coextrusion of the first sublayer and the second sublayer, and wherein the multilayer film has a seal initiation temperature of greater than 105 degrees Celsius.

17. The multilayer film of claim 16, wherein the thermoplastic polyolefin has a modulus from 10 MPa to less than 1,700 MPa.

18. The multilayer film according to claim 16, wherein the multilayer film has a seal initiation temperature from greater than 105 degrees Celsius to 180 degrees Celsius.

19. The multilayer film according to claim 16, further comprising a seal strength from greater than 1.40 N/mm to 20.0 N/mm when sealed at a seal temperature from 127 degrees Celsius to 221 degrees Celsius.

20. The multilayer film according to claim 16, wherein the multilayer film has a peak seal strength from greater than 4.00 N/mm to 20.00 N/mm when sealed ultrasonically at an energy of at least 50 Joules.

21-23. (canceled)
